(19) United States
(12) Patent Application Publication
(10) Pub. No.: US 2026/0360974 A1
(43) Pub. Date: Nov. 12, 2026

(54) ADAPTIVE UNMANNED VEHICLE ANTENNA SYSTEM TO ENHANCE SIGNAL STRENGTH

(71) Applicant: Kaster Boggs, Alpine, UT (US)

(72) Inventor: Kaster Boggs, Alpine, UT (US)

(21) Appl. No.: 19/200,636

(22) Filed: May 6, 2025

(51) Int. Cl. H01Q 3/02; H01Q 1/28; H04B 17/12; H04B 17/391

(52) U.S. Cl. CPC H01Q 3/02; H01Q 1/28; H04B 17/12; H04B 17/3912

(57) ABSTRACT

A self-adjusting antenna system is disclosed for maintaining robust communication between an unmanned vehicle and a ground-based controller or external system. The system includes a directional antenna operably coupled to one or more actuators configured to adjust the antenna's angular orientation. A sensor suite provides real-time data and may include one or more of a signal strength sensor for monitoring received signal strength indicator (RSSI), an inertial measurement unit (IMU) for orientation and motion data, a GPS module for position and altitude tracking, and environmental sensors for detecting wind speed, wind direction, and other relevant environmental parameters. A control unit is operatively coupled to the antenna assembly and the sensors, and is configured to dynamically compute and adjust the antenna's orientation based on real-time data. The control unit may also adjust electronically tunable elements of the antenna to modify beamwidth, enhancing signal gain or field coverage as needed.

### FIELD OF THE INVENTION

This invention relates to a system for maintaining wireless communication with unmanned aerial vehicles (UAVs), and more particularly to a system for dynamically optimizing antenna orientation and signal strength between a UAV and a ground-based controller or communication node.

### BACKGROUND OF THE INVENTION

Unmanned aerial vehicles (UAVs), commonly known as drones, rely on stable communication systems to transmit data such as video feeds and telemetry and receive control signals from ground stations. However, several challenges hinder the reliability of these communication links. One significant issue is line-of-sight (LOS) obstructions, such as buildings or trees, which can block the direct path between the UAV and the ground station, particularly during beyond visual line of sight (BVLOS) operations.

Interference from other wireless devices, power lines, and natural phenomena like solar flares and atmospheric conditions can also degrade signal quality, especially in densely populated areas. Furthermore, signal strength decreases with distance due to free-space path loss, which limits the operational range of UAVs. Doppler shifts, caused by the relative motion between a UAV and a ground station, can disrupt modulation schemes, while multipath propagation in environments with reflective surfaces, like glass buildings or water bodies, may cause signal fading and fluctuating strength.

Existing solutions to these challenges have limitations. For example, omnidirectional antennas, commonly used in consumer drones, provide broad coverage but low gain, which makes them ineffective for long-range or high-interference situations. Directional antennas, such as Yagi or patch antennas, offer higher gain by focusing the signal in a specific direction, but they require precise alignment with the ground station, which is difficult to maintain during flight due to the UAV's constant movement and changing orientation.

Cellular-based backup systems, like DJI's 4G dongle, can provide an alternative communication channel when the primary radio link fails, but these systems incur recurring data costs, introduce latency, and are ineffective in areas without cellular infrastructure. Additionally, these systems react to signal loss rather than preventing it from occurring in the first place.

### SUMMARY

Embodiments of the invention has been developed in response to the present state of the art and, in particular, in response to the problems and needs in the art that have not yet been fully solved by currently available systems and methods. Accordingly, systems and methods in accordance with the invention have been developed to improve communication between unmanned vehicles and their controllers or other external systems. The features and advantages of the disclosed embodiments will become more fully apparent from the following description and appended claims, or may be learned by practice of the embodiments as set forth hereinafter.

Consistent with the foregoing, a self-adjusting antenna system is disclosed for use with unmanned vehicles. More specifically, a system and method is disclosed for dynamically optimizing directional antenna alignment in real time to maintain a robust communication link between an unmanned vehicle and an associated controller.

In one aspect, the system includes an antenna assembly including a directional antenna operably coupled to one or more actuators configured to adjust the angular orientation of the antenna. The angular orientation may include both an azimuthal and an elevational component, thereby enabling three-dimensional steering of the antenna's beam.

The system further includes a sensor suite including one or more of: a signal strength sensor operable to measure Received Signal Strength Indicator (RSSI); an inertial measurement unit (IMU) providing data related to orientation, velocity, and/or acceleration; a GPS module configured to supply position and altitude data; and environmental sensors operable to detect parameters such as wind speed, wind direction, temperature, humidity, and the like.

A control unit is operatively coupled to the antenna assembly and the sensor suite. The control unit is configured to receive real-time data from the sensors to dynamically compute and adjust the antenna's angular orientation to optimize signal strength. In certain embodiments, the control unit implements a gradient descent algorithm or other optimization technique to iteratively converge on an orientation that maximizes signal reception and/or minimizes signal loss. In some embodiments, environmental correction factors may be applied to compensate for adverse atmospheric or kinematic conditions affecting signal propagation.

Additionally, the control unit may in certain embodiments be configured to modify electronically tunable elements of the directional antenna to dynamically adjust the antenna's beamwidth, thereby enhancing gain or field coverage as required by the unmanned vehicle's current operating context.

A corresponding method is also disclosed and claimed herein.

### BRIEF DESCRIPTION OF THE DRAWINGS

In order that the advantages of the various embodiments of invention will be readily understood, a more particular description of the embodiments briefly described above will be rendered by reference to specific embodiments illustrated in the appended drawings. Understanding that these drawings depict only typical embodiments of the invention and are not therefore to be considered limiting of its scope, the embodiments will be described and explained with additional specificity and detail through use of the accompanying drawings, in which:

FIG. 1 shows one embodiment of the invention where a UAV communicates using an omnidirectional antenna and a UAV controller communicates using a dynamically adjustable directional antenna;

FIG. 2 shows another embodiment of the invention where a UAV communicates using a dynamically adjustable directional antenna and a UAV controller communicates using an omnidirectional antenna;

FIG. 3 shows another embodiment of the invention where both a UAV and a UAV controller communicate using a dynamically adjustable directional antenna;

FIG. 4 is a perspective view showing one embodiment of a dynamically adjustable directional antenna mounted on a dual-axis gimbal with servo motors;

FIG. 5 is a high-level block diagram showing one embodiment of a control unit that may be included in one or more of a UAV and a UAV controller to enhance signal strength therebetween;

FIG. 6 is a high-level block diagram showing various modules that may be embodied in hardware, software, and/or firmware of the control unit;

FIG. 7 is a process flow diagram showing one embodiment of a method for dynamically adjusting a directional antenna to enhance signal strength between a UAV and a UAV controller; and

FIG. 8 is a graph showing an example of a difference in signal strength when using a fixed antenna compared to using a dynamically adjustable directional antenna.

### DETAILED DESCRIPTION

It will be readily understood that the components of the embodiments of the invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

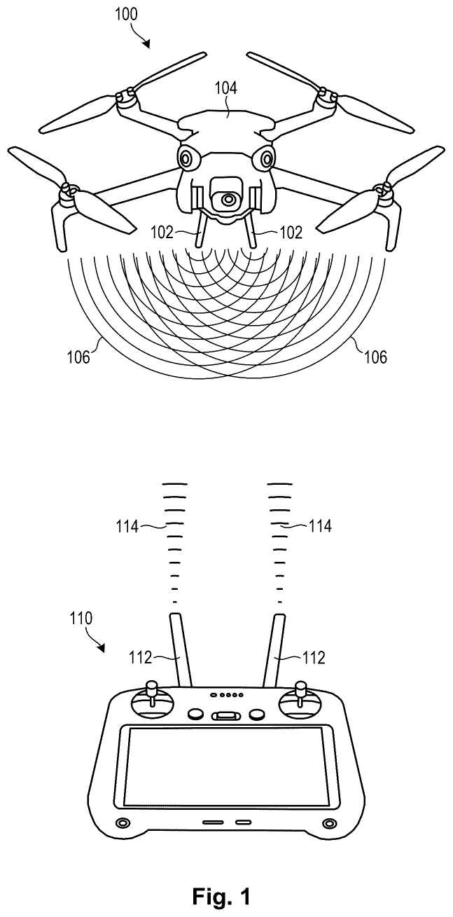

FIG. 1 illustrates one embodiment of a self-adjusting antenna system wherein an unmanned aerial vehicle (UAV) communicates using an omnidirectional antenna, and the ground-based controller communicates using a directional antenna mounted on a self-adjusting actuator assembly. More specifically, as shown in FIG. 1, UAV 100 includes one or more omnidirectional antennas 102 mounted at a fixed location on the UAV 100, such as on the lower, upper, or rear section of the UAV's fuselage 104. In one example, the omnidirectional antenna 102 is a vertically polarized monopole or dipole antenna extending outward from the body of the UAV to reduce electromagnetic obstruction from nearby components. The omnidirectional antennas 102 may radiate and receive signals 106 uniformly in all directions within a horizontal plane, providing a general-purpose communication link that ensures consistent connectivity regardless of the UAV's orientation or heading. This approach is advantageous in scenarios where the UAV's flight path or direction may change rapidly, such as during autonomous navigation, aerial mapping, or dynamic obstacle avoidance.

By contrast, a ground-based controller 110 communicates with the UAV 100 using one or more directional antennas 112, which are configured to focus signal energy in a particular direction to increase effective range and reduce signal dispersion. The directional antennas 112 may take the form of patch antennas, phased arrays, or other high-gain antennas. In certain embodiments, the directional antennas 112 are mounted to an actuator assembly (not shown), which may include at least one electric or servo motor to dynamically control their angular orientation in real time. The actuator assembly may in certain embodiments comprise a dual-axis gimbal or pan-tilt mechanism, allowing for independent or synchronized movement along azimuth (horizontal rotation) and elevation (vertical tilt) axes. For instance, in one embodiment, the azimuth rotation may span 360 degrees with fine angular resolution, while the elevation tilt may range from −10 degrees (below horizon) to +90 degrees (directly overhead) to accommodate various flight altitudes and approach vectors of the UAV. In addition to or instead of using motors, the actuator assembly may also use hydraulic actuators, piezoelectric actuators, magnetic actuators, or the like to dynamically control the angular orientation of the directional antenna 112.

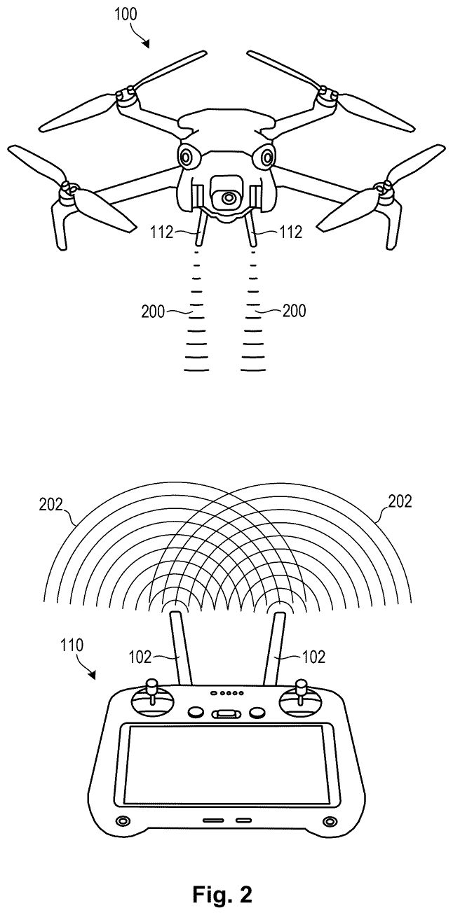

FIG. 2 illustrates another embodiment of the self-adjusting antenna system wherein the UAV 100 communicates using a dynamically adjustable directional antenna 112, while the ground-based controller 110 communicates using an omnidirectional antenna 102. In this embodiment, the UAV 100 includes one or more directional antennas 112 mounted to an onboard actuator assembly. The onboard actuator assembly may include lightweight servo motors, gimbals, or microelectromechanical system (MEMS) components capable of adjusting the azimuth and elevation of the directional antennas 112 in real time.

The actuator assembly may be controlled by onboard logic that may be responsive to UAV orientation, position data, received signal strength such as (RSSI) or other data quality measures such as signal-to-noise ratio or bit error rate, and other data to optimize alignment with the ground-based controller 110. This real-time adjustment enables the UAV 100 to focus its transmitted signal 200 toward the controller 110 for improved link quality, increased range, and/or reduced transmission power. This also enables the directional antenna 112 to be more sensitive and receptive to incoming signals 200.

By contrast, the controller 110 in this embodiment uses an omnidirectional antenna 102, similar to the configuration previously described in FIG. 1. The omnidirectional antenna 102 radiates and receives a signal 202 uniformly in all directions, providing ease of use for portable or mobile deployments where antenna orientation is not easily managed. This embodiment strikes a balance between UAV-side sophistication and ground-side simplicity.

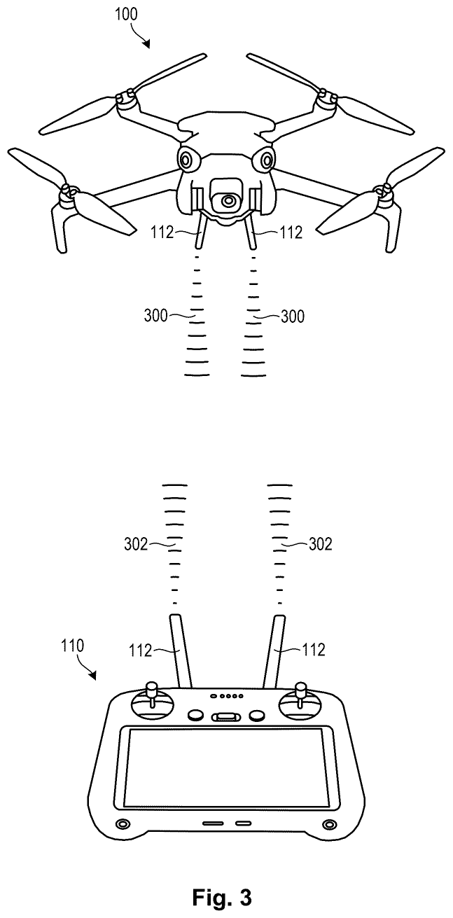

FIG. 3 shows another embodiment of the invention wherein both the UAV 100 and the ground-based controller 110 are equipped with dynamically adjustable directional antennas 112. The UAV 100 includes one or more directional antennas 112 mounted to an actuator assembly, as described in FIG. 2, while the ground-based controller 110 includes similar directional antennas 112 mounted to an actuator assembly.

The ground-based actuator assembly may include one or more motors, gimbals, or pan-tilt systems capable of adjusting the angular orientation of the directional antennas 112 in both azimuth and elevation. The assembly may in certain embodiments be operated based on real-time telemetry data received from the UAV 100, including, for example, GPS coordinates, altitude, and heading, thereby enabling dynamic pointing of the signal 302 toward the UAV 100 during flight.

Likewise, the UAV 100 may use its directional antennas 112 and actuator assembly to track the position of the controller 110. The UAV 100 may calculate the appropriate pointing angle using known position data or feedback from received signal characteristics. In some embodiments, the antenna systems from both the UAV 100 and the ground-based controller 110 may perform an initial scanning routine upon system activation to locate and lock onto one another, followed by continuous dynamic adjustment during operation.

The bidirectional use of directional antennas 112 in this embodiment provides a high-gain communication link with increased resistance to interference, improved range, and better spectral efficiency. This setup may be particularly advantageous for high-bandwidth applications such as real-time video transmission, long-range autonomous missions, or operations in RF-congested environments. Additionally, the use of narrow-beam directional signals 300, 302 enhances signal security by reducing the likelihood of unintended interception. For example, the dual-directional configuration enables the use of narrow beamwidths to avoid signal leakage and reduce susceptibility to eavesdropping or jamming, enhancing both security and communication efficiency.

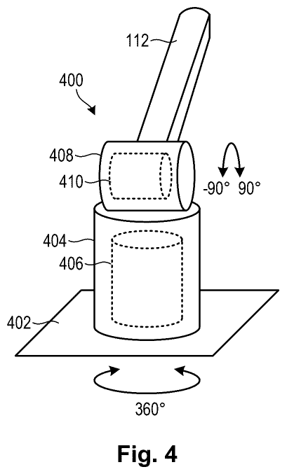

FIG. 4 is a perspective view showing one embodiment of a dynamically adjustable directional antenna mounted on a dual-axis gimbal with servo motors. This view is conceptual in nature and is not intended to represent an actual real-world mechanical implementation of a dual-axis gimbal with servo motors. In this embodiment, a directional antenna 112 is secured to a gimbal assembly 400 that provides precise, motorized adjustment along two orthogonal axes: azimuth (horizontal rotation) and elevation (vertical tilt). The gimbal assembly 400 includes a base platform 402 affixed to a stable mounting surface on the UAV 100 or ground-based controller 110.

Mounted atop the base platform 402 is a first rotational joint 404 that enables the antenna assembly to pivot about a vertical axis, thereby controlling the azimuth angle. This joint may be driven by a first servo motor 406, which may provide smooth, controlled horizontal movement based on received targeting data or manual control inputs.

Attached to the first rotational joint 404 is a second rotational joint 408, which holds the directional antenna 112 and permits tilting of the directional antenna 112 about a horizontal axis to adjust the elevation angle. This second rotational joint 408 is powered by a second servo motor 410, enabling precise vertical aiming.

The combination of azimuth and elevation control allows the directional antenna 112 to be aimed with high precision in three-dimensional space. In one embodiment, the servo motors 406 and 410 are electronically controlled via an onboard microcontroller or remote command system that receives real-time positioning data of the UAV 100 (see FIG. 1), such as GPS coordinates, heading, and altitude. For the purposes herein, the term “GPS” is used broadly to include any types of positional coordinates or location.

The directional antenna 112 may be a Yagi array, phased array, or other suitable type for focused RF transmission and/or reception. In certain embodiments, the gimbal assembly 400 is equipped with position sensors or encoders to provide closed-loop feedback for accurate tracking and stabilization, even in windy or mobile conditions. This design enables the antenna system to maintain a robust, narrow-beam communication link with a moving aerial platform or ground-based controller 110 while compensating for both UAV and environmental motion.

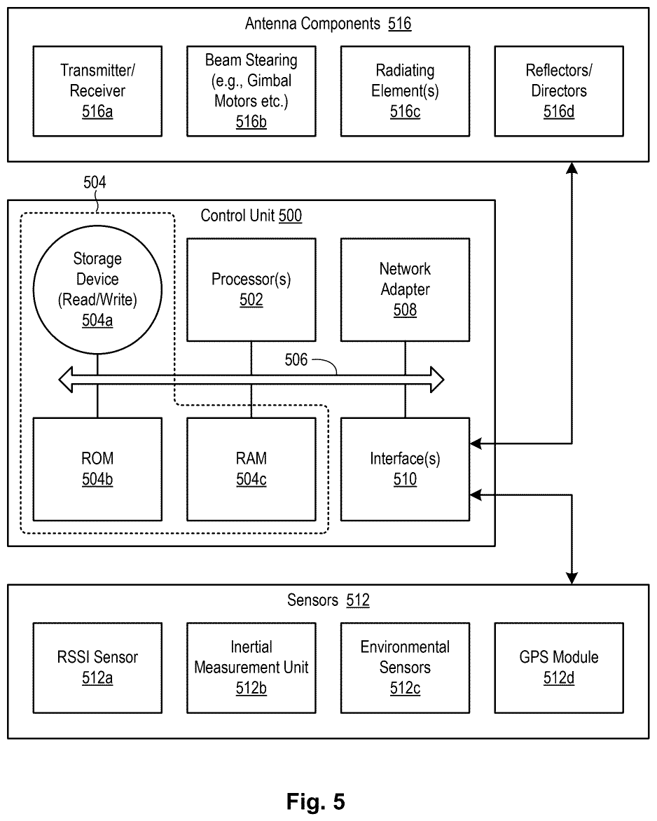

FIG. 5 is a high-level block diagram showing one embodiment of a control unit 500 that may be included in one or both of the UAV 100 and the ground-based controller 110 to enhance signal strength and communication quality between the two components 100, 110. Control unit 500 may be implemented as a dedicated hardware module, an embedded controller, or as part of a more comprehensive onboard computing platform.

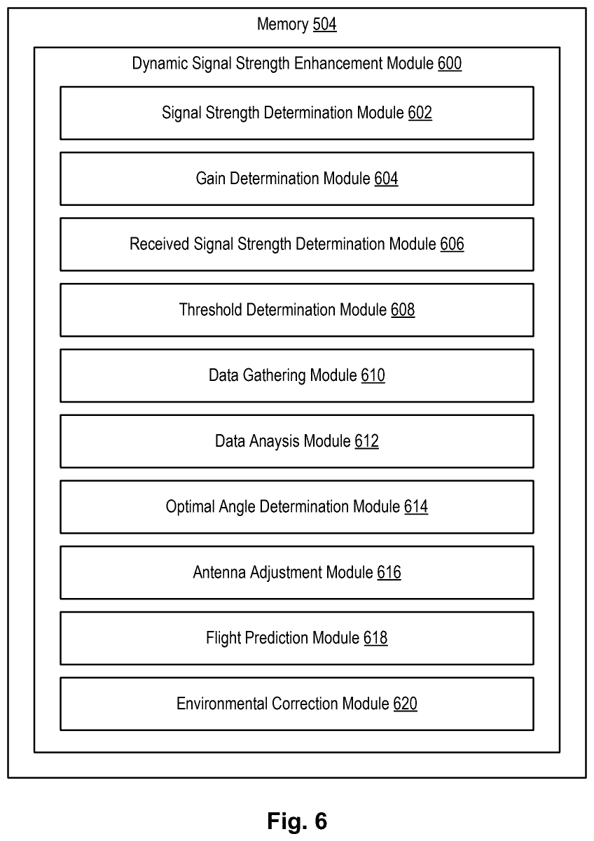

The control unit 500 includes one or more processors 502, which may include a general-purpose microprocessor, digital signal processor (DSP), field-programmable gate array (FPGA), application-specific integrated circuit (ASIC), or the like, configured to execute control logic and signal processing algorithms. The processor(s) 502 are communicatively coupled to various forms of memory 504, which may include read/write storage devices 504a (e.g., SSD, flash memory, etc.), read-only memory (ROM) 504b, and random access memory (RAM) 504c for runtime operations. Various modules that may be executed in the control unit 500 will be discussed in association with FIG. 6.

A network adapter 506 may be included to enable communication with external systems or peripheral components, such as telemetry links, remote control interfaces, mesh networking modules, or the like. One or more input/output interfaces 510 provide connectivity for external sensors, actuators, communication subsystems, and the like.

As shown, the control unit 500 is further configured to interface with a set of sensors 512. In one embodiment, these sensors include a received signal strength indicator (RSSI) sensor 512a, which provides real-time feedback on the strength of incoming radio signals. This data may be used to guide beam-steering decisions or trigger realignment of directional antennas. An inertial measurement unit (IMU) 512b, comprising one or more of accelerometers, gyroscopes, magnetometers, and like, may be used to monitor the orientation and movement of the host platform. Environmental sensors 512c may gather environmental data such as wind speed, wind direction, temperature, humidity, barometric pressure, precipitation levels, fog levels, electromagnetic inference levels, radiation levels, etc., to provide contextual data for adaptive control of a directional antenna 112. The control unit 500 and or sensors 512 may also incorporate a global positioning system (GPS) module 512d to provide geolocation data used for directional alignment of a directional antenna 112, link prediction, or motion compensation.

In one concrete non-limiting example of sensors 512 that may be included in a sensor suite, a signal strength sensor 512a may be provided that continuously measures the Received Signal Strength Indicator (RSSI) over a dynamic range from −120 dBm, near the noise floor, to −20 dBm, representing a strong signal. The sensor 512a may operate at a sampling rate of 100 samples per second, or 10-millisecond intervals, and offer a sensitivity of +1 dBm, allowing the system to detect and respond to even subtle variations in signal quality.

An onboard inertial measurement unit (IMU) 512b may provide high-fidelity motion and orientation data. In one example, the IMU 512b includes a three-axis accelerometer with a range of ±16 g, a gyroscope with a rotational range of ±2000 degrees per second, and a magnetometer capable of detecting magnetic fields up to ±8 Gauss. The sensor 512b may output roll, pitch, and yaw data with a resolution of 0.1 degrees, along with velocity and acceleration, all updated at a frequency of 100 Hz to support smooth and responsive control logic.

Environmental sensors 512c complement this data by capturing external conditions that may affect flight dynamics or signal propagation. An anemometer may measure wind speed from 0 to 30 meters per second with an accuracy of ±0.1 m/s and wind direction from 0° to 360° with ±3° precision. Temperature may be monitored over a wide operating range of −40 °C to ±85 °C, with ±0.5 °C accuracy, while humidity may be measured across 0 to 100% relative humidity with ±2% accuracy.

A GPS module 512d provides global positioning data, including latitude, longitude, and altitude, with positional accuracy to within one meter. It may update at a rate of 10 Hz and support predictive flight path calculations used by the flight prediction and antenna alignment algorithms to anticipate UAV movement and maintain continuous signal alignment. The foregoing sensors represent just one example of a sensor suite and are not intended to be limiting.

Antenna components 516 form the communication front-end and may include multiple subsystems. For example, transmitter/receiver circuitry 516a may be responsible for modulating and demodulating radio signals to and from the antenna. A beam-steering module 516b, which may include gimbal motors, phased-array drivers, or other electromechanical actuators, may dynamically adjust the direction of signal propagation and/or reception. Radiating elements 516c form the physical antennas, and may include patch arrays, dipoles, or parabolic reflectors. Optionally, reflectors or directors 516d may be included to shape the radiation pattern for greater directional gain or reduced side-lobe interference.

One concrete non-limiting example of a directional antenna 112 for use with the disclosed system includes a Yagi antenna with 5 to 10 elements or a phased array, designed to provide significantly higher gain—typically in the range of 10 to 20 dBi—compared to the 2 to 5 dBi gain of standard omnidirectional antennas. The antenna type may be selected to balance gain with beamwidth, which generally falls between 20° and 40°. Mechanically, the antenna may be mounted on a dual-axis gimbal system powered by two high-torque servo motors, each capable of delivering approximately 5 kg·cm of torque with a fine angular resolution of 0.1°. The azimuth axis may support full 360° continuous rotation, while the elevation axis may permit tilt adjustment from −90° (directly downward) to ±90° (directly upward), allowing for complete hemispherical coverage. The gimbal may be capable of responding to orientation commands within 100 milliseconds.

The directional antenna 112 may include optional electronic tuning capabilities through the use of varactors or PIN diodes, which allow dynamic adjustment of the antenna's beamwidth between 10° and 60°. These adjustments may be controlled by voltage signals from the control unit 500 and allow for real-time trade-offs between directional gain and coverage area. Structurally, the antenna assembly may be constructed with lightweight yet durable materials, such as a carbon fiber frame to maintain rigidity while keeping the weight under 100 grams, and aluminum elements for efficient conductivity and environmental durability. The entire antenna assembly may be enclosed in an IP54-rated housing to provide resistance to dust and water, such as rain at rates up to 10 mm/h, making it suitable for outdoor and UAV-mounted applications. This represents just one example of a directional antenna 112 and is not intended to be limiting.

In operation, the control unit 500 may continuously monitor incoming signal strength, platform orientation, and positional data to optimize antenna orientation and signal directionality. The control unit 500 may adjust beam-steering components to maintain or enhance the communication link between the UAV 100 and the controller 110, especially during dynamic flight, long-range operations, or in RF-challenging environments.

In one embodiment, the control unit 500 is a compact, embedded microcontroller-based system designed for real-time signal management and actuator control within an aerial or ground-based communication system. For example, the control unit may include a 32-bit ARM Cortex-M4 microcontroller operating at a clock speed of 100 MHz and including floating-point computation capabilities to support high-precision real-time signal processing, control loop execution, and coordinate transformations. Such a microcontroller may be supported by 256 KB of RAM used for buffering incoming sensor data and storing intermediate values during antenna steering computations, as well as 1 MB of onboard flash memory for firmware storage, lookup tables, and calibration constants. The unit may be powered by a wide-range DC input (5-24V), making it directly compatible with typical UAV or mobile battery systems, and consume less than 1 watt of power under full computational and actuation load. For sensor integration, the control unit 500 may include an I2C interface for communication with an onboard inertial measurement unit (IMU) and environmental sensors. A dedicated SPI bus may be used to interface with a signal strength sensor 512a, such as an RSSI module, allowing for low-latency, high-throughput signal quality monitoring. Additionally, a UART interface may be used to control servo motors responsible for physical antenna orientation, and optionally, tuning elements such as electronically controlled phase shifters or matching networks. The control logic may in certain embodiments be implemented in embedded C firmware and support over-the-air (OTA) update functionality, allowing for remote patching and performance tuning without requiring direct physical access to the device.

Referring to FIG. 6, a high-level block diagram is provided showing various modules that may be used to implement various features and functions of the invention. These modules may be implemented in hardware, software, firmware, or combinations thereof. The modules are presented by way of example and not limitation. More or fewer modules may be provided in different embodiments. For example, the functionality of some modules may be combined into a single or smaller number of modules, or the functionality of a single module may be distributed across several modules.

FIG. 6 is a high-level functional block diagram illustrating one embodiment of a dynamic signal strength enhancement module 600 that may be implemented in hardware, software, firmware, or combinations thereof. For example, the dynamic signal strength enhancement module 600 may be implemented all or in part as software stored in memory 504 and executed by the processor(s) 502 of control unit 500 (see FIG. 5). The dynamic signal strength enhancement module 600 may include a set of interrelated modules configured to collectively monitor, analyze, and optimize signal strength between the UAV 100 and ground-based controller 110 by adjusting antenna orientation and/or transmission characteristics in real time.

The dynamic signal strength enhancement module 600 may in certain embodiments include a signal strength determination module 602 to calculate the power of the signal that is received by the antenna of the UAV 100 or the ground-based controller 110. In certain embodiments, the signal strength determination module 602 utilizes the Friis Transmission Equation to calculate the power received by the UAV 100's antenna over a given distance as expressed by:

$${P}_{r} = {P}_{t} \cdot {G}_{t} \cdot {G}_{r} \cdot {( \frac{λ}{4 π d} )}^{2}$$

where Pᵣ represents the received power at the UAV's antenna, Pₜ is the transmitted power from the base station, Gₜ is the gain of the transmitting antenna (indicating how well it directs the signal), and Gᵣ is the gain of the receiving antenna (measuring how effectively it captures the signal). The variable λ represents the signal's wavelength, which is related to its frequency, while d is the distance between the transmitter and receiver (such as the UAV and its base station).

The Friis Transmission Equation may serve as the foundation for evaluating the signal strength received by a UAV 100 from its base station, whether it's a controller or a communication tower. Several factors influence the received power Pᵣ, and understanding these elements is important for maintaining a stable and reliable connection. The transmitted power Pₜ determines the initial signal strength, but as the signal propagates, its power diminishes due to distance. The transmitting antenna's gain Gₜ affects how well the signal is focused toward the UAV 100 100, while the receiving antenna's gain Gᵣ influences how efficiently the UAV 100 captures the signal. A higher Gₜ ensures that more power is directed toward the intended receiver, while a higher Gᵣ allows the UAV 100 to pick up weaker signals from farther away.

The wavelength λ is inversely related to the signal's frequency. Higher frequency signals have shorter wavelengths, allowing for more compact antennas but making them more susceptible to attenuation. Lower frequency signals, with longer wavelengths, tend to propagate better over long distances but require larger antennas. The equation also accounts for free-space path loss, represented by the (λ/4πd)₂ term, which describes how the signal weakens as it spreads out over increasing distance. As a result, the farther the UAV 100 moves from the transmitter, the more the signal power diminishes.

Maintaining a strong received signal Pᵣ is important for reliable UAV control and uninterrupted data transmission. If Pᵣ falls below a certain threshold, the UAV 100 may experience lag, signal degradation, or even complete loss of control, triggering automatic safety measures such as a return-to-home function. To counteract this, one effective approach is dynamically adjusting the receiving antenna's gain Gᵣ. By adapting the antenna's direction and optimizing its gain, the system can sustain a strong connection even as the UAV 100 moves, changes altitude, or rotates.

In addition to antenna adjustments, other strategies can improve communication reliability. Increasing transmit power Pₜ, selecting operating frequencies with lower interference, and optimizing antenna placement may contribute to better signal performance. By understanding and applying the Friis Transmission Equation, the communication system can be fine tuned to achieve optimal performance, ensuring stable and efficient connectivity between the UAV 100 and its base station 110.

The dynamic signal strength enhancement module 600 may also include a gain determination module 604 to calculate the gain of an antenna (e.g., the UAV's or base station's antenna) based on its orientation. In certain embodiments, the gain determination module 604 may utilize the antenna gain model to describe how a UAV's antenna gain, Gᵣ, varies based on its orientation in terms of an elevation angle θ and the azimuth angle φ, as set forth in the following equation:

Gᵣ(θ,φ)=Gₘₐₓ·cos²(θ)·cos²(φ)

Here, Gₘₐₓ represents the maximum gain when the antenna is perfectly aligned with the signal source. The elevation angle, θ, determines the tilt of the antenna up or down from the horizontal plane, while the azimuth angle, φ, controls the side-to-side rotation. The presence of the cos² terms indicates that the gain is at its highest when θ and φ are both zero, meaning the antenna is perfectly aligned. As these angles deviate from zero, the gain decreases, reflecting the reduced efficiency of signal reception.

This model is useful because a UAV's antenna ideally remains directed toward a base station 110 to maintain optimal signal strength. By dynamically adjusting θ and φ, the system may ensure that Gᵣ stays as close to Gₘₐₓ as possible, thereby maximizing the received signal strength.

The dynamic signal strength enhancement module 600 may also include a received signal strength determination module 606 to determine and monitor a Received Signal Strength Indicator (RSSI). This RSSI may be derived from the received power Pᵣ using the following equation:

S=10·log₁₀(Pᵣ).

The equation converts received power into RSSI, measured in decibels (dB), providing a practical way to assess signal quality. The process works by using Pᵣ, which is obtained from the Friis equation discussed above. The logarithmic scale, achieved by multiplying by 10 and applying the base-10 logarithm, compresses large or small power values into a more manageable range. A higher S value corresponds to a stronger signal, meaning that, for example, −30 dB represents a better signal than −70 dB.

This optimization is important because RSSI, in certain embodiments, is the key metric the system aims to maximize. By linking RSSI to Pᵣ and further associating Pᵣ with the antenna gain Gᵣ, the UAV 100 can dynamically adjust its antenna angles to enhance signal strength and thereby provide clear and stable communication.

In one embodiment, the received signal strength determination module 606 performs continuous signal monitoring by sampling, using the RSSI sensor 512a, the received signal strength indicator (RSSI) at selected intervals (e.g., 10 milliseconds) to detect fluctuations in communication quality. The threshold determination module 608 may determine if the measured signal strength falls below a predefined threshold (e.g., −80 dBm) so that corrective adjustments can be made. Thresholds may be configurable and may be adapted to suit specific mission requirements. For instance, a higher threshold such as −60 dBm may be used when supporting bandwidth-intensive applications like live video streaming. Upon detecting a signal degradation that crosses a threshold, the data gathering module 610 may be configured to begin collecting data. For example, real-time orientation and motion data may be retrieved from the inertial measurement unit (IMU) 512b, while geographic position and trajectory may be retrieved from the global positioning system (GPS) module 512d. The data gathering module 610 may also retrieve environmental data such as wind or temperature data from the environmental sensors 512c to assess external factors that may influence signal propagation or platform stability.

Using this multi-source input, the data analysis module 612 may execute a data fusion and analysis process that integrates orientation, position, and environmental data into a mathematical model. The optimal angle determination module 614 may then use this model to compute optimal antenna orientation angles, including elevation (θ) and azimuth (Φ), with the goal of maximizing signal strength and maintaining robust connectivity. This computation may be executed at repeated intervals (e.g., 50-millisecond intervals) to ensure a balance between responsiveness and system stability. The antenna adjustment module 616 may then transmit the optimal computed angles to servo motors or beam-steering components, which physically or electronically reposition the directional antenna 112. In certain embodiments, antenna adjustment is typically completed within 100 milliseconds. Following repositioning, RSSI values may then be re-sampled to confirm signal improvement. If signal quality does not meet target thresholds, the system may initiate further iterations until optimal performance is achieved.

In certain embodiments, the optimal angle determination module 614 may utilize an algorithm such as a gradient descent algorithm to fine-tune the antenna angles, θ and φ, step-by-step to maximize the Received Signal Strength Indicator (RSSI), denoted as S in the equation above. The algorithm iteratively adjusts these angles based on the gradient of S with respect to each angle.

The equations governing this process are:

$$\begin{matrix}{θ}_{n + 1} = {θ}_{n} + α \frac{\partial S}{\partial θ} \\ {ϕ}_{n + 1} = {ϕ}_{n} + α \frac{\partial S}{\partial ϕ}\end{matrix}$$

Here, θₙ and φₙ represent the current antenna angles at step n, while α is a small step size (e.g., 0.01) that controls the magnitude of each adjustment. The partial derivatives

$$\frac{\partial S}{\partial θ} and \frac{\partial S}{\partial ϕ}$$

indicate how much S changes when θ or φ shifts slightly, helping the system move toward an optimal signal angle. Each iteration updates θ and φ to move them closer to the peak RSSI. The algorithm may dynamically adjust the antenna angles in real time, ensuring they remain optimized for the strongest possible signal as the UAV 100 moves.

The flight prediction module 618 may be configured to analyze UAV flight path data to anticipate signal degradation and adjust preemptively. In certain embodiments, the flight prediction module 618 utilizes flight path prediction equations to estimate the UAV's future position based on its current location and velocity, as follows:

x(t+Δt)=x(t)+vₓ·Δt

y(t+Δt)=y(t)+v_{y}·Δt

z(t+Δt)=z(t)+v_{z}·Δt

This method works by using the UAV's current coordinates, represented as x(t), y(t), and z(t), which define its position in terms of left/right, forward/back, and up/down movement. The UAV's velocity components in each direction are denoted by vₓ, v_{y}, and v_{z}, measured in units such as meters per second. A small time step, Δt (e.g., 0.1 seconds), is used to incrementally calculate the future position. By multiplying the velocity by the time step and adding it to the current position, the flight prediction module 618 may estimate the UAV's next location.

This approach may be used to maintain a strong signal connection. By knowing the UAV's predicted position, the system can proactively adjust the antenna's orientation. If the UAV is moving away from the base station 110, the antenna 112 can in certain embodiments tilt in advance to maintain an optimal signal.

The environmental correction module 620 may be configured to dynamically adjust antenna angles to compensate for wind pushing the UAV 100 around. In certain embodiments, the environmental correction module 620 uses various environmental correction equations to adjust the antenna angles to compensate for wind disturbances affecting the UAV 100. The adjusted angles, θ_{adjusted} and φ_{adjusted}, may be calculated by incorporating a constant scaling factor Cₑ, the wind speed w, and the wind direction y relative to the UAV's heading, as indicated in the following equations:

θ_{adjusted}=θ+C_{θ}·w·sin(ψ)

φ_{adjusted}=φ+C_{θ}·w·cos(ψ)

Here, θ and φ represent the original angles from the gradient descent algorithm. The constant scaling factor Cₑ is tuned to the UAV's design. The wind speed w determines the force of the environmental disturbance, while sin(ψ) and cos(ψ) decompose the wind's impact into vertical and horizontal components.

This adjustment may be useful to counteract potential misalignment of an antenna 112 by the wind causing a UAV 100 to tilt or shift. By applying this correction, the system attempts to keep the signal strong and stable to ideally compensate for environmental disruptions and maintain reliable communication.

All of the above modules and associated equations may work together to provide strong and reliable signal transmission for the UAV's communication system. The Friis equation may serve as the foundation by calculating the signal strength based on distance and environmental factors. Building on this, the antenna gain model may establish how the signal strength is influenced by the orientation of the antenna 112, ensuring that the best alignment is maintained for optimal reception. To keep the system efficient, the Received Signal Strength Indicator (RSSI) acts as a real-time feedback mechanism, providing a target value that is maximized for a strong and stable connection.

The gradient descent algorithm is employed as a mathematical approach to iteratively adjust the antenna angles, gradually converging on the best possible alignment for maximum signal strength. However, because the UAV 100 is constantly moving, flight path prediction comes into play by estimating future positions based on velocity and direction, allowing the system to proactively adjust for upcoming changes. Lastly, environmental corrections may account for unpredictable real-world disturbances such as wind, which can tilt or shift the UAV 100 and misalign the antenna 112. By incorporating wind speed and direction into the adjustments, the system attempts to ensure continuous alignment and a stable signal despite external interferences.

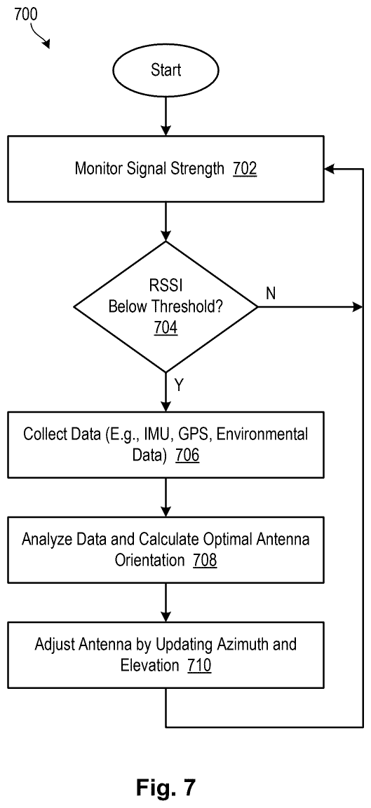

FIG. 7 is a high-level flow diagram illustrating one embodiment of an automated signal optimization process 700 for dynamically enhancing signal strength between a UAV 100 and a ground-based controller 110. The process begins at block 702, where the system initiates monitoring of signal strength, specifically by sampling the received signal strength indicator (RSSI) at regular intervals. At decision block 704, the system evaluates whether the measured RSSI falls below a predetermined signal strength threshold, which may be based on mission-specific requirements (e.g., higher thresholds for video streaming or lower for telemetry-only applications). If the RSSI remains above the threshold, no corrective action is taken, and the process loops back to continue monitoring.

If the RSSI is found to be below the threshold (i.e., suboptimal), the system proceeds to block 706, where it collects relevant contextual data. This may include orientation and motion data from the inertial measurement unit (IMU) 512b, positional data from the GPS module 512d, and external conditions such as wind speed or direction from the environmental sensors 512. In block 708, the collected data is analyzed to compute an optimal antenna orientation using a mathematical model or algorithm such as gradient descent. The calculation determines new elevation and azimuth angles that are expected to improve the antenna's gain and restore signal strength.

At block 710, the system adjusts the antenna's physical orientation based on the computed azimuth and elevation values. This adjustment may involve driving servo motors, beam-steering elements, or phased-array controls depending on the specific antenna architecture used. Following the adjustment, the system returns to block 702 and resumes signal monitoring, allowing for closed-loop optimization. This loop ensures that the antenna 112 remains properly aligned in real-time with respect to the UAV's position, movement, and environmental influences, thereby maintaining a robust and continuous communication link.

In one specific example of the method 700 of FIG. 7, the method 700 performs continuous signal monitoring 702 by sampling the received signal strength indicator (RSSI) every 10 milliseconds to detect fluctuations in communication quality. If the measured signal strength falls 704 below a predefined threshold—such as −80 dBm—the method 700 initiates corrective adjustments. These thresholds are configurable and may be adapted to suit specific mission requirements. For instance, a higher threshold such as −60 dBm may be used when supporting bandwidth-intensive applications like live video streaming. Upon detecting 704 signal degradation, the method 700 begins 706 a data collection phase, in which an inertial measurement unit (IMU) 512b provides real-time orientation and motion data, while a global positioning system (GPS) module 512d tracks the UAV's geographic position and projects its future trajectory. Environmental sensors 512c, such as wind or temperature sensors, are also queried to assess external factors that may influence signal propagation or platform stability.

In one example scenario of system operation, a UAV 100 is flying at an altitude of approximately 100 meters and is located 500 meters away from a ground-based communication station. The UAV 100 is traveling forward at a velocity of 10 meters per second, while experiencing a crosswind of 5 meters per second originating from 90 degrees relative to its heading. Initially, the received signal strength indicator (RSSI) is measured at −70 dBm, which is acceptable but suboptimal for sustaining high-bandwidth communication tasks such as real-time 4K video transmission. During flight, the UAV 100 undergoes a yaw maneuver, causing the RSSI to degrade to −72 dBm. This drop in signal strength is detected by the control unit 500, which receives yaw angle data from the onboard inertial measurement unit (IMU) 512b, indicating a 15-degree yaw. Concurrently, GPS data confirms that the UAV's overall flight trajectory remains stable.

To compensate for the effect of the crosswind on the antenna's pointing accuracy, an environmental wind sensor 512c detects the 5 m/s lateral wind and contributes a corrective adjustment of +0.25 degrees to the computed elevation angle. Taking into account the UAV's dynamic orientation, position, and environmental input, the control unit 500 calculates an updated elevation angle (e) of 30 degrees and a forward-facing azimuth angle (f) of 45 degrees for optimal antenna orientation. These computed parameters are sent to the actuator assembly, which reorients the directional antenna 112 in real time. As a result of the adjustment, the RSSI improves significantly, rising to −50 dBm—an enhancement of 20 dB—sufficient to support continuous high-bandwidth communication without degradation or packet loss. This entire optimization and realignment sequence occurs within approximately 150 milliseconds, ensuring that the communication link remains uninterrupted and robust during dynamic flight conditions.

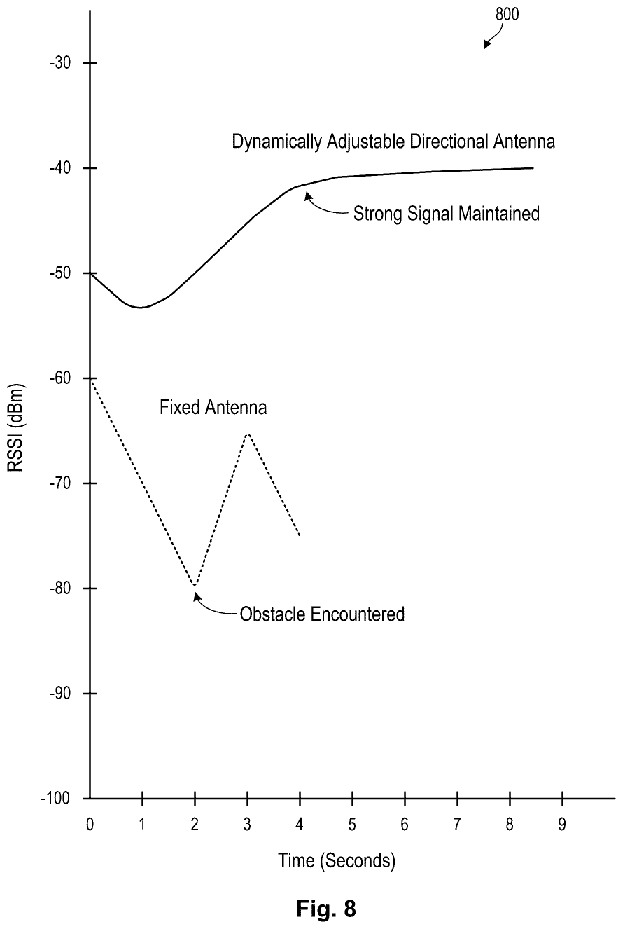

FIG. 8 is a time-based performance graph 800 illustrating one example of signal strength behavior over time for two different antenna configurations: a fixed antenna and a dynamically adjustable directional antenna 112 as used in the communication system between a UAV 100 and a ground-based controller 110. The horizontal axis represents time in seconds, while the vertical axis represents the received signal strength indicator (RSSI) in decibels-milliwatts (dBm). Two signal profiles are plotted for comparison. The first curve, labeled “Fixed Antenna,” represents the RSSI received by a system in which the antenna orientation remains static throughout the operation. The second curve, labeled “Dynamically Adjustable Directional Antenna,” shows the RSSI received when the antenna orientation is actively controlled and adjusted in real time according to the algorithms and modules described in FIGS. 5 through 7.

As shown in the graph 800, both antenna configurations begin with a similar signal strength. However, as the UAV 100 continues moving and an obstacle is encountered partway through the timeline, the fixed antenna experiences a rapid degradation in signal strength, with the RSSI dropping significantly below −70 dBm, indicating poor reception that may compromise control or data transmission. By contrast, the dynamically adjustable antenna 112 maintains a strong and stable signal throughout the duration of the event. This stability is achieved through real-time adjustments of antenna orientation (e.g., azimuth and elevation angles) based on sampled RSSI values, IMU data, GPS trajectory, and environmental factors such as wind.

The graphical result demonstrates the effectiveness of the dynamic signal strength enhancement module 600 (as detailed in FIG. 6), which continuously monitors RSSI, detects signal degradation, and calculates and applies corrective adjustments within milliseconds. The superior performance of the dynamically adjustable directional antenna system, particularly when challenged by obstacles or changing orientation, confirms the advantages of closed-loop antenna control and predictive optimization techniques for maintaining reliable, high-quality communication links between a UAV 100 and a control station 110.

Compared to systems utilizing omnidirectional antennas, the present system offers significantly higher gain and more focused signal transmission, resulting in stronger and more reliable communication. Unlike fixed directional antenna setups, which require manual realignment or suffer performance degradation when the UAV changes orientation, this system dynamically adjusts to UAV motion in real time without user intervention. Additionally, when compared to cellular-based backup solutions such as DJI's 4G dongle, this system delivers multiple advantages. It is more cost-efficient, eliminating the need for recurring data fees or dependence on third-party network infrastructure. It offers lower latency, maintaining near-instantaneous communication with delays of less than 10 milliseconds through a direct radio link. The system also provides improved reliability, functioning independently of cellular coverage and ensuring continued connectivity even in remote or obstructed environments. Importantly, it supports proactive adjustment of the communication link, continuously optimizing the primary connection rather than waiting for a failure to trigger a switch to a backup channel.

While embodiments of the present invention are described primarily in the context of unmanned aerial vehicles (UAVs), it is not limited to aerial applications. The disclosed system and methods may be applied to a wide variety of unmanned vehicles, including but not limited to unmanned aerial vehicles (UAVs), unmanned ground vehicles (UGVs), unmanned surface vehicles (USVs), and other remotely operated or autonomous platforms. Similarly, the controller or communication node with which the unmanned vehicle communicates need not be ground-based. In various embodiments, the controller may be located on another vehicle, aboard a manned aircraft, on a marine vessel, or integrated into a mobile or satellite-based system. Accordingly, references to UAVs and ground-based controllers should be understood to encompass other types of unmanned vehicles and control architectures, and the invention should not be construed as being limited to any particular vehicle type or communication topology.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112 (f) unless the element is expressly recited in the claims using the phrase “means for” or, in the case of a method claim, the element is recited using the phrase “step for.”

While various examples have been described above, it should be understood that they have been presented by way of example only, and not by way of limitation. Likewise, the various diagrams may depict an example architectural or other configuration for the disclosure, which is done to aid in understanding the features and functionality that can be included in the disclosure. The disclosure is not restricted to the illustrated example architectures or configurations, but can be implemented using a variety of alternative architectures and configurations. Additionally, although the disclosure is described above in terms of various example examples and aspects, it should be understood that the various features and functionality described in one or more of the individual examples are not limited in their applicability to the particular example with which they are described. They instead can be applied, alone or in some combination, to one or more of the other examples of the disclosure, whether or not such examples are described, and whether or not such features are presented as being a part of a described example. Thus the breadth and scope of the present disclosure should not be limited by any of the above-described examples.

Terms and phrases used in this application, and variations thereof, especially in the appended claims, unless otherwise expressly stated, should be construed as open ended as opposed to limiting. As examples of the foregoing, the term ‘including’ should be read to mean ‘including, without limitation,’ ‘including but not limited to,’ or the like; the term ‘including’ as used herein is synonymous with ‘including,’ ‘containing,’ or ‘comprising,’ and is inclusive or open-ended and does not exclude additional, unrecited elements or method steps; the term ‘having’ should be interpreted as ‘having at least;’ the term ‘includes’ should be interpreted as ‘includes but is not limited to;’ the term ‘example’ is used to provide example instances of the item in discussion, not an exhaustive or limiting list thereof; adjectives such as ‘known’, ‘normal’, ‘standard’, and terms of similar meaning should not be construed as limiting the item described to a given time period or to an item available as of a given time, but instead should be read to encompass known, normal, or standard technologies that may be available or known now or at any time in the future; and use of terms like ‘preferably,’ ‘preferred,’ ‘desired,’ or ‘desirable,’ and words of similar meaning should not be understood as implying that certain features are critical, essential, or even important to the structure or function of the described subject matter, but instead as merely intended to highlight alternative or additional features that may or may not be utilized in a particular example of the described subject matter. Likewise, a group of items linked with the conjunction ‘and’ should not be read as requiring that each and every one of those items be present in the grouping, but rather should be read as ‘and/or’ unless expressly stated otherwise. Similarly, a group of items linked with the conjunction ‘or’ should not be read as requiring mutual exclusivity among that group, but rather should be read as ‘and/or’ unless expressly stated otherwise.

All numbers expressing quantities, amounts, and so forth used in the specification are to be understood as being modified in all instances by the term ‘about.’ Accordingly, unless indicated to the contrary, the numerical parameters set forth herein are approximations that may vary depending upon the desired results sought to be obtained.

Furthermore, although the foregoing has been described in some detail by way of illustrations and examples for purposes of clarity and understanding, it is apparent to those skilled in the art that certain changes and modifications may be practiced. Therefore, the description and examples should not be construed as limiting the scope of the described subject matter to the specific examples and examples described herein, but rather to also cover all modification and alternatives coming with the true scope and spirit of the described subject matter.

1. A self-adjusting antenna system for an unmanned vehicle, the system comprising:
an antenna assembly comprising a directional antenna operably coupled to an actuator to dynamically adjust an angular orientation of the directional antenna;
a set of sensors configured to measure at least one of signal strength, unmanned vehicle movement dynamics, and environmental conditions;
a control unit operatively coupled to the antenna assembly and sensors, wherein the control unit is configured to dynamically optimize the angular orientation using real-time data gathered from the sensors; and
the control unit further configured to autonomously maintain optimal communication between the unmanned vehicle and a controller by adjusting the angular orientation in response to changes to at least one of the signal strength, unmanned vehicle movement dynamics, and environmental conditions.

2. The self-adjusting antenna system of claim 1, wherein the actuator comprises at least one motor.

3. The self-adjusting antenna system, of claim 2, wherein the angular orientation comprises an azimuth component and an elevation component.

4. The self-adjusting antenna system of claim 1, wherein the sensors include a signal strength sensor measuring Received Signal Strength Indicator (RSSI).

5. The self-adjusting antenna system of claim 1, wherein the sensors include an inertial measurement unit (IMU) providing at least one of orientation, velocity, and acceleration data.

6. The self-adjusting antenna system of claim 1, wherein the sensors include an environmental sensor detecting at least one of wind speed and direction.

7. The self-adjusting antenna system of claim 1, wherein the sensors include a GPS module to provide position and altitude data.

8. The self-adjusting antenna system of claim 1, wherein the control unit employs a gradient descent algorithm to maximize signal strength.

9. The self-adjusting antenna system of claim 1, wherein the control unit is further configured to apply environmental correction to the angular orientation.

10. The self-adjusting antenna system of claim 1, wherein the control unit is further configured to adjust electronically tunable elements of the directional antenna to adjust at least one of beamwidth, polarization, and gain.

11. A method for maintaining optimal communication between an unmanned vehicle and a controller, the method comprising:
operating an antenna assembly including a directional antenna;
actuating the directional antenna to dynamically adjust its angular orientation;
collecting real-time data from a set of sensors measuring at least one of signal strength, unmanned vehicle movement dynamics, and environmental conditions; and
dynamically optimizing the angular orientation of the directional antenna based on the real-time data to autonomously maintain communication.

12. The method of claim 11, wherein actuating the directional antenna comprises using at least one motor to control its movement.

13. The method of claim 12, wherein dynamically adjusting the angular orientation comprises adjusting an azimuth component and an elevation component.

14. The method of claim 11, further comprising measuring signal strength using a signal strength sensor configured to detect Received Signal Strength Indicator (RSSI).

15. The method of claim 11, further comprising collecting movement dynamics data from an inertial measurement unit (IMU) configured to detect at least one of orientation, velocity, and acceleration.

16. The method of claim 11, further comprising detecting at least one of wind speed and direction using an environmental sensor.

17. The method of claim 11, further comprising obtaining position and altitude data from a GPS module.

18. The method of claim 11, further comprising using a gradient descent algorithm to iteratively optimize the antenna's angular orientation to maximize signal strength.

19. The method of claim 11, further comprising applying environmental correction to the angular orientation based on the environmental conditions.

20. The method of claim 11, further comprising adjusting electronically tunable elements of the directional antenna to adjust at least one of beamwidth, polarization, and gain based on the real-time data.
